(19) United States
(12) Patent Application Publication
(10) Pub. No.: US 2018/0069286 A1
(43) Pub. Date: Mar. 8, 2018

(54) WAVEGUIDE TUBE/TRANSMISSION LINE CONVERTER AND ANTENNA DEVICE

(71) Applicant: Japan Radio Co., Ltd., Tokyo (JP)

(72) Inventor: Masayuki Sugano, Tokyo (JP)

(21) Appl. No.: 15/560,396

(22) PCT Filed: Mar. 18, 2016
(86) PCT No.: PCT/JP2016/058847

§ 371 Date: Sep. 21, 2017

(30) Foreign Application Priority Data
Mar. 23, 2015 (JP) 2015-058860
Feb. 1, 2016 (JP) 2016-016965

(51) Int. Cl. H01P 5/107; H01Q 13/08; H01Q 21/06

(52) U.S. Cl. CPC H01P 5/107; H01Q 21/06; H01Q 13/08

(57) ABSTRACT

A metal member which allows a waveguide to extend inside a dielectric substrate and is adapted to hold a short-circuit metal layer at a potential same as a potential of the waveguide is made to remain along cross-sections of the two wide walls of the waveguide and is removed along cross-sections of two narrow walls of the waveguide so as to prevent an electromagnetic wave from unintendedly being radiated.

### TECHNICAL FIELD

The present disclosure relates to (1) a waveguide/transmission line converter to convert power transmitted by a waveguide and power transmitted by a transmission line to each other, and (2) an antenna device having antenna elements arranged in a lattice shape on a plane and having power fed from the waveguide/transmission line converter.

### BACKGROUND ART

The waveguide/transmission line converter is applied to feed power and the like to an antenna device and disclosed in, for example, Patent Literature 1 and 2. First, according to the Patent Literature 1, a transmission line is inserted at a position inside the waveguide where electric field intensity is high. However, according to the Patent Literature 1, a waveguide short-circuit surface is needed at a position distant from the transmission line along the waveguide by a distance equal to approximately ¼ of a wavelength of an electromagnetic wave inside the waveguide. Therefore, in the Patent Literature 1, the waveguide/transmission line converter cannot be downsized and a structure forming the short-circuit surface exists more in front than a surface forming an antenna device, thereby causing deterioration of directivity of the antenna device.

### CITATION LIST

### Patent Literature

Patent Literature 1: Japanese Patent Application Laid-Open No. 2004-320460

Patent Literature 2: Japanese Patent Application Laid-Open No. 2000-244212

### SUMMARY OF INVENTION

### Technical Problem

Next, according to Patent Literature 2, utilized is a technique of coupling a transmission line to a matching element to propagate radio waves from a transmission line to a waveguide. As it can be understood from the following description, according to the Patent Literature 2, compared to Patent Literature 1, a waveguide/transmission line converter can be more downsized and a structure forming a short-circuit surface causing deterioration of directivity of the antenna device can be eliminated.

FIG. 1 illustrates a structure of a waveguide/transmission line converter in the related art. An uppermost stage illustrates a side-sectional view of a waveguide/transmission line converter 1′. A second stage illustrates a plan-sectional view taken along an arrow A′-A′ of the waveguide/transmission line converter 1′. A third stage illustrates a plan-sectional view taken along an arrow B′-B′ of the waveguide/transmission line converter 1′. A lowermost stage illustrates electric field distribution in a resonant length direction of a matching element 17′ described later.

The waveguide/transmission line converter 1′ includes a dielectric substrate 13′, a short-circuit metal layer 14′, a metal member 15′, a ground metal layer 16′, and a matching element 17′.

The dielectric substrate 13′ is arranged in a manner blocking an opening of the waveguide 11′. A surface of the dielectric substrate 13′ is the surface perpendicular to a waveguide direction of the waveguide 11′. In the second and third stages of FIG. 1, a portion of the dielectric substrate 13′ where a pattern is arranged is indicated by a white background and a portion of the dielectric substrate 13′ where no pattern is arranged is indicated by hatching.

The short-circuit metal layer 14′ is arranged on a surface of the dielectric substrate 13′ and outside the waveguide 11′, and held at a potential same as that of the waveguide 11′ by the metal member 15′ penetrating the dielectric substrate 13′ and the ground metal layer 16′ arranged on a surface of the dielectric substrate 13′ and at an outer frame of the waveguide 11′.

The matching element 17′ is arranged on the surface of the dielectric substrate 13′ and inside the waveguide 11′ and electromagnetically coupled to the transmission line 12′ via the dielectric substrate 13′, in which a resonant length (approximately λ_{g}′/2) adapted to set up, as a standing wave, an electromagnetic wave having an effective wavelength λ_{g}′ in a surrounding environment of the dielectric substrate 13′ is in an electric field direction inside the waveguide 11′ and in a feed power direction of the transmission line 12′.

Only one transmission line 12′ is arranged in the description for FIG. 1. As a modified example, two transmission lines 12′ extending in opposite directions may be arranged. However, it is not necessary to arrange two matching elements 17′, and arranging only one is enough. Additionally, the two transmission lines 12′ extending in the opposite directions may share the one matching element 17′.

FIG. 2 illustrates an exemplary structure of an antenna device utilizing a technique in the related art. An antenna device 2′ is not disclosed in the Patent Literature 1 and 2. In the antenna device 2′, antenna elements are arranged in a lattice shape on a plane. The antenna elements arranged in a lattice shape are divided per antenna elements 21′ in each column. The antenna elements 21′ in each column are fed power from two transmission lines 12′ which are connected to the waveguide/transmission line converter 1′ arranged in a center of each column, and extend in opposite directions (described as the modified example in the previous paragraph). The dielectric substrate 13′ is a plane on which the antenna elements are arranged in a lattice shape. A cross-section of a wide wall of the waveguide 11′ is arranged in a direction perpendicular to a direction of each column. A cross-section of a narrow wall of the waveguide 11′ is arranged in a direction parallel to the direction of each column.

Since the antenna elements 21′ in each column are fed power in the center of each column, a result of synthesizing the respective antenna elements constituting each column can form directivity having high gain in one arbitrary direction in a wide frequency range even when excitation phases of the respective antenna elements constituting each column are deviated from each other at a frequency deviated from a center frequency of the antenna device 2′.

However, a size p_{w}′ in a direction along the cross-section of the wide wall of the waveguide 11′ (refer to FIG. 1) out of sizes of patterns arranged on the surface of the dielectric substrate 13′ becomes inevitably large in the waveguide/transmission line converter 1′. Therefore, in the antenna device 2′, a distance d′ between the antenna elements 21′ in respective columns adjacent to each other becomes inevitably wider than a length λ₀/2 that is equal to half a wavelength λ₀ of a radiated electromagnetic wave. Consequently, a visible region in an array antenna becomes inevitably wide, and grating lobe is more likely to occur in directivity of the array antenna formed of the respective antenna elements constituting the respective columns, particularly at the time of adjusting phase information of respective antenna elements and performing beam scanning to a wide field of view.

Accordingly, to solve the above-described problem, the present disclosure is directed to providing: a waveguide/transmission line converter in which a size in a direction along a cross-section of a wide wall of a waveguide out of sizes of patterns arranged on a surface of a dielectric substrate is reduced; and an antenna device in which a distance between antenna elements in respective column adjacent to each other is narrowed and grating lobe is made to hardly occur in directivity of an array antenna formed of the respective antenna elements constituting the respective columns, particularly at the time of adjusting phase information of the respective antenna elements and performing beam scanning to a wide field of view.

### Solution to Problem

To achieve the above-described objects, applied is a fact that in a waveguide slot antenna, an electromagnetic wave is not radiated in the case where a slot to be provided on a narrow wall is provided in a direction parallel to the cross-section of the narrow wall, because current flowing along the narrow wall flows in a direction parallel to a cross-section of the narrow wall. In other words, a metal member which allows a waveguide to extend inside a dielectric substrate and is adapted to hold a short-circuit metal layer at a potential same as that of the waveguide is made to remain along cross-sections of two wide walls of the waveguide and removed along cross-sections of both or a cross-section of one of two narrow walls of the waveguide so as to prevent an electromagnetic wave from unintendedly being radiated.

Specifically, the present disclosure provides a waveguide/transmission line converter adapted to convert power transmitted by a waveguide and power transmitted by a transmission line to each other, and the waveguide/transmission line converter includes: a dielectric substrate arranged in a manner blocking an opening of the waveguide; a short-circuit metal layer arranged on a surface of the dielectric substrate and outside of the waveguide, and held at a potential same as a potential of the waveguide by a metal member penetrating the dielectric substrate along cross-sections of two wide walls of the waveguide or by a metal member penetrating the dielectric substrate along the cross-sections of the two wide walls and a cross-section of one of two narrow walls of the waveguide; and a matching element arranged on a surface of the dielectric substrate and inside the waveguide, and coupled to the transmission line, in which a resonant length adapted to set up, as a standing wave, an electromagnetic wave having an effective wavelength in a surrounding environment of the dielectric substrate is in an electric field direction inside the waveguide and in a feed power direction of the transmission line.

With this structure, it is possible to reduce a size in the direction along the cross-section of the wide wall of the waveguide out of sizes of patterns arranged on the surface of the dielectric substrate.

Additionally, the present disclosure provides the waveguide/transmission line converter further including a dielectric layer formed on surfaces of the transmission line and the short-circuit metal layer.

With this structure, it is possible to increase an effective dielectric constant in the surrounding environment of the waveguide/transmission line converter and reduce a size of a pattern around the waveguide/transmission line converter.

Furthermore, the present disclosure provides the waveguide/transmission line converter wherein the dielectric layer has a thickness of 0.2 times or less of an effective wavelength of an electromagnetic wave in the surrounding environment of the waveguide/transmission line converter.

With this structure, in order to cover a region where an electric field may leak from the dielectric substrate between the transmission line and the matching element, the dielectric layer is required to have only a minimal thickness.

Moreover, the present disclosure provides the waveguide/transmission line converter wherein a plurality of the transmission lines extend in at least one of two directions away from the waveguide/transmission line converter along a resonant length direction of the matching element.

With this structure, it is possible to achieve an antenna array in a direction perpendicular to a feed power direction with only one waveguide/transmission line converter, and high degree of freedom is provided to performance of an array antenna.

Furthermore, the present disclosure provides an antenna device having antenna elements arranged in a lattice shape on a plane, wherein the antenna elements arranged in a lattice shape are divided per antenna elements arranged in each column, power is fed to the antenna elements arranged in each column by the transmission line connected to a waveguide/transmission line converter arranged in a center of each column, the dielectric substrate is a plane on which the antenna elements are arranged in a lattice shape, a cross-section of a wide wall of the waveguide is arranged in a direction perpendicular to each column, a cross-section of a narrow wall of the waveguide is arranged in a direction parallel to each column.

With this structure, a distance between the antenna elements in respective columns adjacent to each other is narrowed, and grating lobe can be made to hardly occur in directivity of the array antenna formed of the respective antenna elements constituting the respective columns, particularly at the time of adjusting phase information of respective antenna elements and performing beam scanning to a wide field of view.

### Advantageous Effects of Invention

Thus, according to the present disclosure, provided are: the waveguide/transmission line converter in which the size in a direction along the cross-section of the wide wall of the waveguide out of the sizes of the patterns arranged on the surface of the dielectric substrate is reduced; and the antenna device in which the distance between the antenna elements in the respective columns adjacent to each other is narrowed, and grating lobe can be made to hardly occur in directivity of the array antenna formed of the respective antenna elements constituting the respective columns, particularly at the time of adjusting phase information of respective antenna elements and performing beam scanning to a wide field of view.

### BRIEF DESCRIPTION OF DRAWINGS

FIG. 1 is a diagram illustrating a structure of a waveguide/transmission line converter in related art.

FIG. 2 is a diagram illustrating an exemplary structure of an antenna device utilizing a technique in the related art.

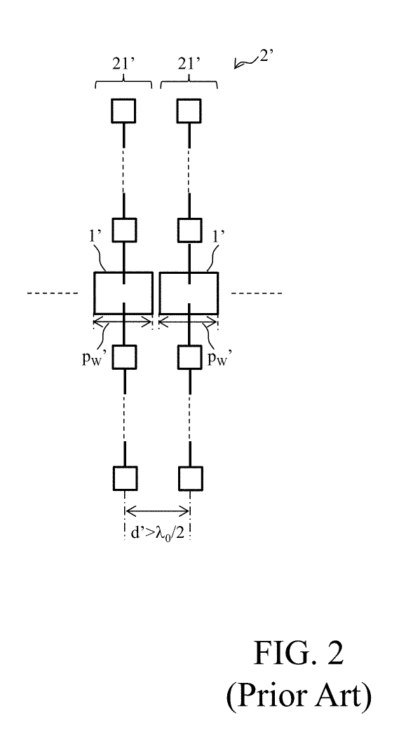

FIG. 3 is a diagram illustrating a structure of a waveguide/transmission line converter according to a first embodiment.

FIG. 4 is a diagram illustrating characteristics of the waveguide/transmission line converter according to the first embodiment.

FIG. 5 is a diagram illustrating a structure of an antenna device according to the first embodiment.

FIG. 6 is a diagram illustrating a structure of the antenna device according to the first embodiment.

FIG. 7 is a diagram illustrating a structure of a waveguide/transmission line converter according to a second embodiment.

FIG. 8 is a diagram illustrating a structure of a waveguide/transmission line converter according to a third embodiment.

FIG. 9 is a diagram illustrating a structure of an antenna device according to the third embodiment.

FIG. 10 is a diagram illustrating a structure of the antenna device according to the third embodiment.

### DESCRIPTION OF EMBODIMENTS

Embodiments of the present disclosure will be described with reference to the attached drawings. The embodiments described below are work examples of the present disclosure, and the present disclosure is not limited to the following embodiments. These work examples are merely examples, and the present disclosure can be implemented in a mode having various modifications and improvements based on knowledge of those skilled in the art. Note that a constituent element denoted by a same reference sign in the present specification and drawings indicate a constituent element mutually same.

### First Embodiment

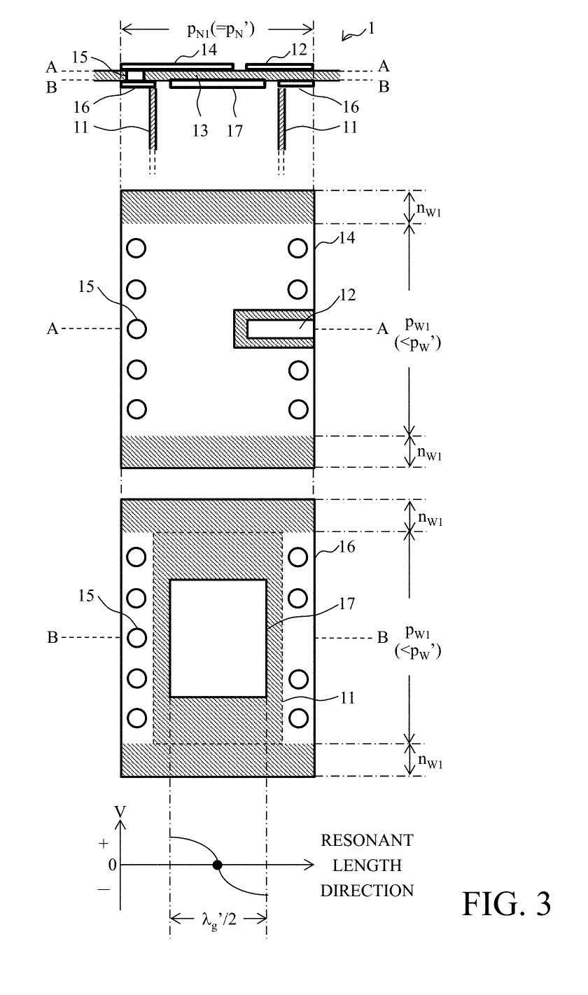

FIG. 3 illustrates a structure of a waveguide/transmission line converter according to a first embodiment. An uppermost stage illustrates a side-sectional view of a waveguide/transmission line converter 1. A second stage illustrates a plan-sectional view taken along an arrow A-A of the waveguide/transmission line converter 1. A third stage illustrates a plan-sectional view taken along an arrow B-B of the waveguide/transmission line converter 1. A lowest stage illustrates electric field distribution in a resonant length direction of a matching element 17 described later.

The waveguide/transmission line converter 1 includes a dielectric substrate 13, a short-circuit metal layer 14, a metal member 15, a ground metal layer 16, and the matching element 17.

The dielectric substrate 13 is arranged in a manner blocking an opening of a waveguide 11. A surface of the dielectric substrate 13 is the surface perpendicular to a waveguide direction of the waveguide 11. In the second and third stages of FIG. 3, a portion of the dielectric substrate 13 where a pattern is arranged is indicated by a white background, and a portion of the dielectric substrate 13 where no pattern is arranged is indicated by hatching.

The short-circuit metal layer 14 is arranged on a surface of the dielectric substrate 13 and outside the waveguide 11, and held at a potential same as that of the waveguide 11 by the metal member 15 penetrating the dielectric substrate 13 along cross-sections of two wide walls of the waveguide 11 and the ground metal layer 16 arranged on a surface of the dielectric substrate 13 and at an outer frame of the waveguide 11. In other words, the metal member 15 and the ground metal layer 16, which allow the waveguide 11 to extend inside the dielectric substrate 13 and are adapted to hold the short-circuit metal layer 14 at the potential same as that of the waveguide 11, are made to remain along the cross-sections of the two wide walls of the waveguide 11 and removed along cross-sections of two narrow walls of the waveguide 11 so as to prevent an electromagnetic wave from unintendedly being radiated.

The matching element 17 is arranged on the surface of the dielectric substrate 13 and inside the waveguide 11 and electromagnetically coupled to the transmission line 12 via the dielectric substrate 13, in which a resonant length (approximately λ_{g}′/2) adapted to set up, as a standing wave, an electromagnetic wave having an effective wavelength λ_{g}′ in a surrounding environment of the dielectric substrate 13 is in an electric field direction inside the waveguide 11 and in a feed power direction of the transmission line 12.

Here, the matching element 17 and the transmission line 12 exist in separate layers. Additionally, an end shape of the transmission line 12 is a stub provided with a cut-away portion or a slot. Therefore, the matching element 17 and the transmission line 12 can achieve electromagnetic coupling.

In the description for FIG. 3, the metal member 15 is formed as a “through hole” penetrating the dielectric substrate 13 along the cross-sections of the two wide walls of the waveguide 11. As a first modified example, the metal member 15 may be a “conductor wall” penetrating the dielectric substrate 13 along the cross-sections of the two wide walls of the waveguide 11. As a second modified example, the metal member 15 may be formed as a “through hole” penetrating the dielectric substrate 13 along the cross-sections of the two wide walls and a cross-section of one of two narrow walls of the waveguide 11. As a third modified example, the metal member 15 may be a “conductor wall” penetrating the dielectric substrate 13 along the cross-sections of the two wide walls and the cross-section of one of the two narrow walls of the waveguide 11.

In the description for FIG. 3, only one transmission line 12 is arranged. As a modified example, two transmission lines 12 extending in opposite directions may be arranged. However, it is not necessary to arrange two matching elements 17, and arranging only one is enough. Then, the two transmission lines 12 extending in the opposite directions may share one matching element 17.

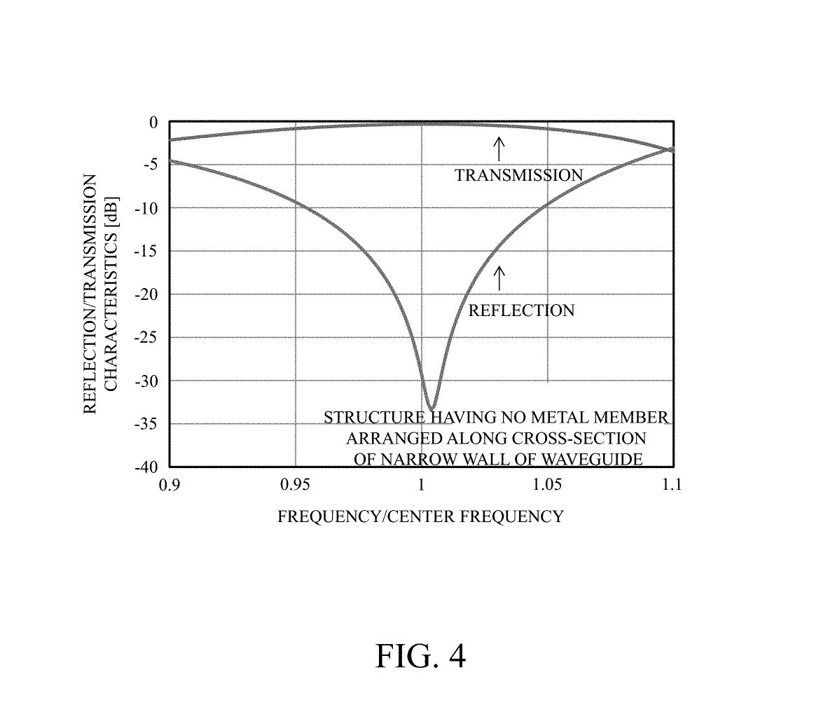

FIG. 4 illustrates characteristics of the waveguide/transmission line converter according to the first embodiment. Thus, according to the first embodiment, in a manner similar to the related art, a low reflection characteristic and a high transmission characteristic can be achieved even in a frequency deviated from a center frequency of the waveguide/transmission line converter 1 by a bandwidth.

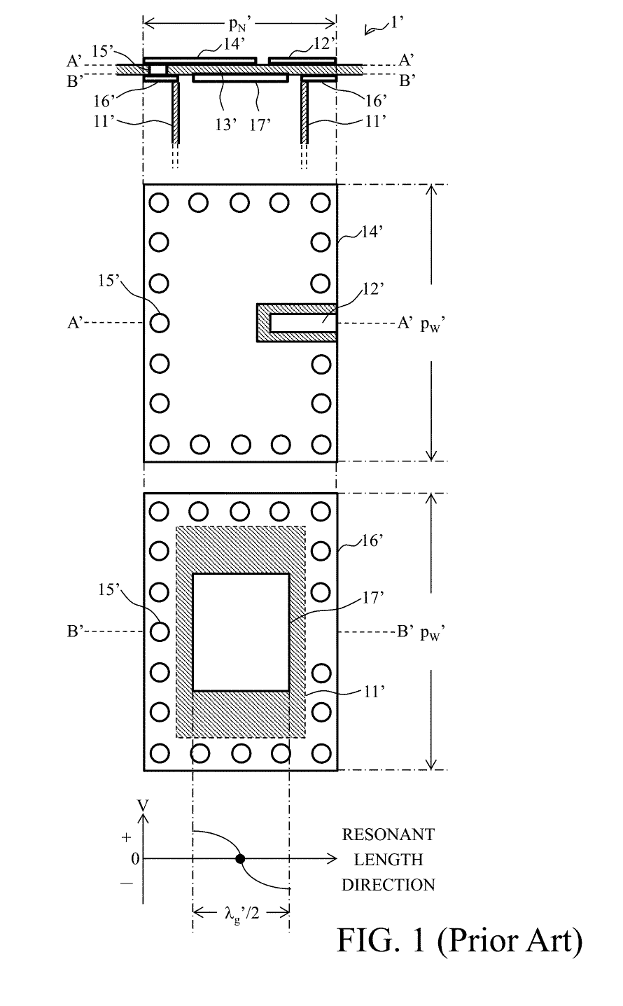

Additionally, according to the first embodiment, compared to the related art, a size p_{W1} (refer to FIG. 3) in a direction along the cross-section of the wide wall of the waveguide 11 out of sizes of patterns arranged on the surface of the dielectric substrate 13 can be reduced by a removal width 2n_{W1} or n_{W1} (refer to FIG. 3) of the metal member 15 and the ground metal layer 16 which have been removed along the cross-sections of both or the cross-section of one out of the two narrow walls of the waveguide 11. Specifically, compared to the size p_{W}′ in FIG. 1, the size p_{W1} in FIG. 3 is about ⅔ in millimeter wave application in which the size of the metal member 15 cannot be ignored.

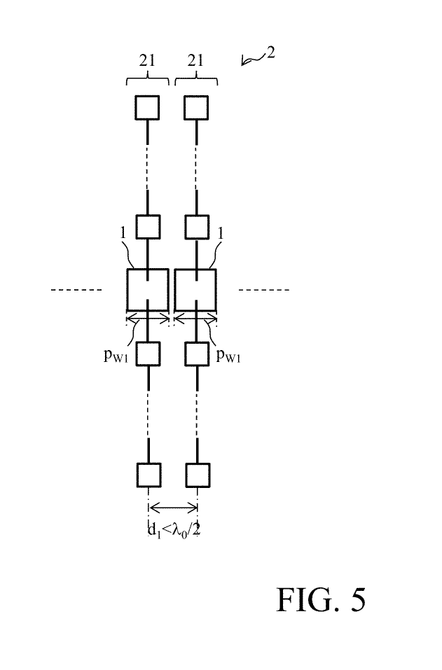

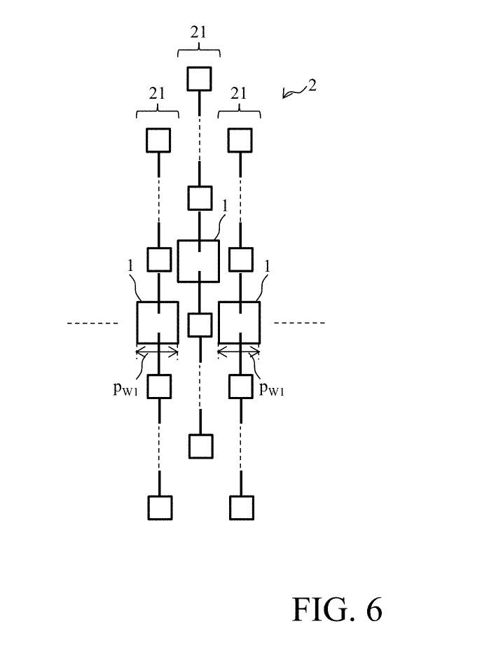

FIGS. 5 and 6 illustrate structures of an antenna device according to the first embodiment. In the antenna device 2, the antenna elements are arranged in a lattice shape on a plane. In FIG. 5, the waveguide/transmission line converter 1 is arranged on a straight line in a horizontal direction of the drawing. In FIG. 6, the waveguide/transmission line converter 1 is arranged in a zigzag manner in the horizontal direction of the drawing. The antenna elements arranged in a lattice shape are divided per antenna elements 21 in each column. The antenna elements 21 in each column are fed power from two transmission lines 12 which are connected to the waveguide/transmission line converter 1 arranged in a center of each column and extend in opposite directions (described as the modified example two paragraphs before). The dielectric substrate 13 is a plane on which the antenna elements are arranged in a lattice shape. The cross-section of the wide wall of the waveguide 11 is arranged in a direction perpendicular to a direction of each column. The cross-section of the narrow wall of the waveguide 11 is arranged in a direction parallel to the direction of each column.

Since the antenna elements 21 in each column have power fed in the center of each column, a result of synthesizing the respective antenna elements constituting each column can form directivity having high gain in one arbitrary direction in a wide frequency range even when excitation phases of the respective antenna elements constituting each column are deviated from each other at a frequency deviated from a center frequency of the antenna device 2.

Additionally, in the waveguide/transmission line converter 1, the size p_{W1} (refer to FIG. 3) in the direction along the cross-section of the wide wall of the waveguide 11 out of sizes of the patterns arranged on the surface of the dielectric substrate 13 can be reduced by a removal width 2n_{W1} or n_{W1} (refer to FIG. 3) of the metal member 15 and the ground metal layer 16 which have been removed along the cross-sections of both or the cross-section of one of the two narrow walls of the waveguide 11. Specifically, compared to the size p_{W}′ in FIG. 1, the size p_{W1} in FIG. 3 is about ⅔ in millimeter wave application in which the size of the metal member 15 cannot be ignored.

Therefore, in the antenna device 2, a distance d₁ between the antenna elements 21 in the respective columns adjacent to each other can be made narrower than a length λ₀/2 that is equal to half a wavelength λ₀ of a radiated electromagnetic wave, a visible region in an array antenna can be narrowed, and grating lobe hardly occurs in directivity of the array antenna formed of the respective antenna elements constituting the respective columns, particularly at the time of adjusting phase information of the respective antenna elements and performing beam scanning to a wide field of view.

### Second Embodiment

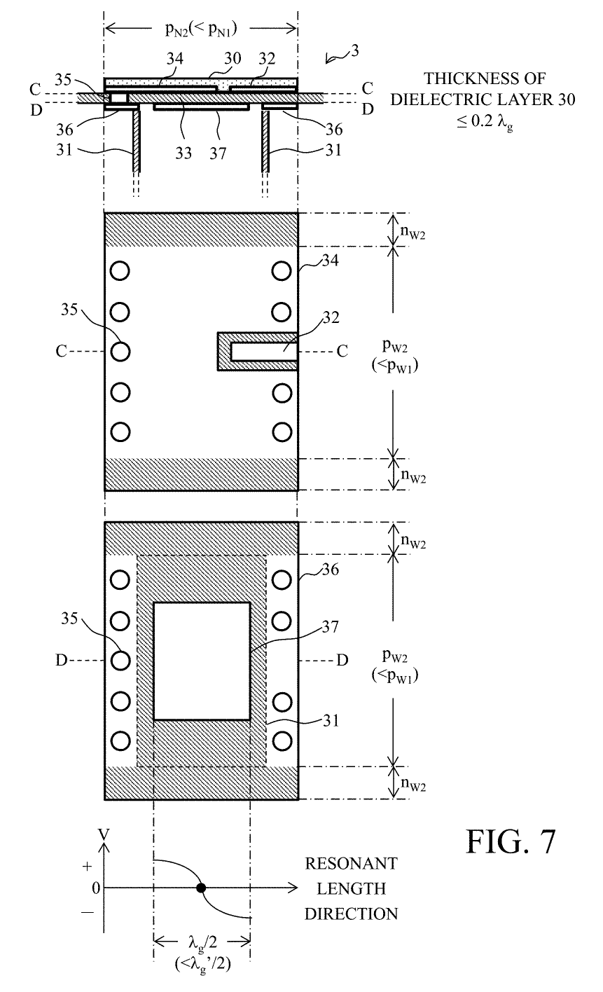

FIG. 7 illustrates a structure of a waveguide/transmission line converter according to a second embodiment. An uppermost stage illustrates a side-sectional view of a waveguide/transmission line converter 3. A second stage illustrates a plan-sectional view taken along an arrow C-C of the waveguide/transmission line converter 3. A third stage illustrates a plan-sectional view taken along an arrow D-D of the waveguide/transmission line converter 3. A lowest stage illustrates electric field distribution in a resonant length direction of a matching element 37 described later.

The waveguide/transmission line converter 3 includes a dielectric substrate 33, a short-circuit metal layer 34, a metal member 35, a ground metal layer 36, a matching element 37, and a dielectric layer 30 in order to convert power transmitted by a waveguide 31 and power transmitted by a transmission line 32 to each other.

The waveguide 31, transmission line 32, dielectric substrate 33, short-circuit metal layer 34, metal member 35, ground metal layer 36, and matching element 37 of the second embodiment in FIG. 7 are substantially similar to a waveguide 11, a transmission line 12, a dielectric substrate 13, a short-circuit metal layer 14, a metal member 15, a ground metal layer 16, and a matching element 17 of a first embodiment in FIG. 3, respectively.

The matching element 37 is arranged on a surface of the dielectric substrate 33 and inside the waveguide 31, and electromagnetically coupled to the transmission line 32 via the dielectric substrate 33, in which a resonant length (approximately λ_{g}/2) adapted to set up, as a standing wave, an electromagnetic wave having an effective wavelength λ_{g} (described later together with the dielectric layer 30) in a surrounding environment of the matching element 37 is in an electric field direction inside the waveguide 31 and in a feed power direction of the transmission line 32.

The dielectric layer 30 is formed in contact with or close to surfaces of the transmission line 32 and of the short-circuit metal layer 34. Therefore, in the second embodiment, compared to the first embodiment, an effective dielectric constant in the surrounding environment of the waveguide/transmission line converter 3 can be increased and the effective wavelength λ_{g} of an electromagnetic wave in the surrounding environment of the waveguide/transmission line converter 3 can be shortened, and sizes p_{N2} and p_{W2} in a direction along cross-sections of a narrow wall and a wide wall of the waveguide 31 can be reduced.

The dielectric layer 30 desirably has a thickness of 0.2 times or less of the effective wavelength λ_{g} of the electromagnetic wave in the surrounding environment of the waveguide/transmission line converter 3. Accordingly, in order to cover a region where an electric field may leak from the dielectric substrate 33 between the transmission line 32 and the matching element 37, the dielectric layer 30 is required to have only a minimal thickness. Additionally, even when the dielectric layer 30 having the minimal thickness (0.2 times or less of λ_{g}) is formed in millimeter wave application in which a thickness (about 0.5 mm or less) of the dielectric substrate 33 is reduced, strength of the waveguide/transmission line converter 3 can be increased, and a size of the waveguide/transmission line converter 3 can be reduced. In the description for FIG. 7, the dielectric layer 30 is formed only on the surfaces of the transmission line 32 and the short-circuit metal layer 34. As a modified example of FIG. 7, the dielectric layer 30 may be formed on an entire surface of the dielectric substrate 33.

### Third Embodiment

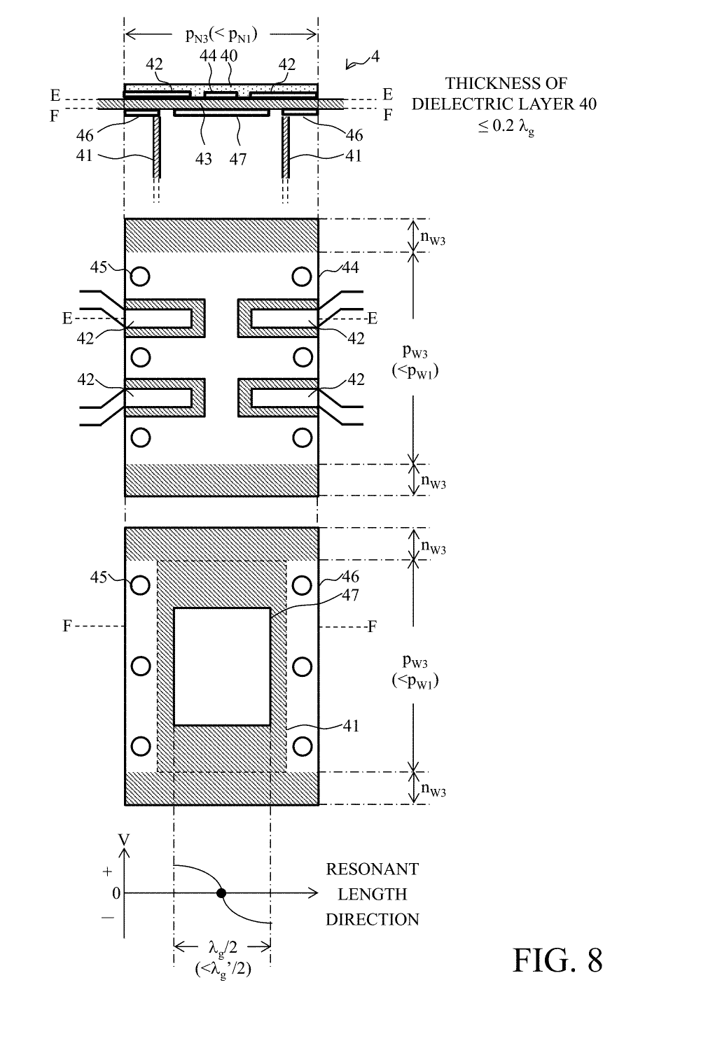

FIG. 8 illustrates a structure of a waveguide/transmission line converter according to a third embodiment. An uppermost stage illustrates a side-sectional view of a waveguide/transmission line converter 4. A second stage illustrates a plan-sectional view taken along an arrow E-E of the waveguide/transmission line converter 4. A third stage illustrates a plan-sectional view taken along an arrow F-F of the waveguide/transmission line converter 4. A lowest stage illustrates electric field distribution in a resonant length direction of a matching element 47 described later.

The waveguide/transmission line converter 4 includes a dielectric substrate 43, a short-circuit metal layer 44, a metal member 45, a ground metal layer 46, a matching element 47, and a dielectric layer 40 in order to convert power transmitted by a waveguide 41 and power transmitted by a transmission line 42 to each other.

The waveguide 41, transmission line 42, dielectric substrate 43, short-circuit metal layer 44, metal member 45, ground metal layer 46, matching element 47, dielectric layer 40, sizes p_{N3} and p_{W3}, and an effective wavelength λ_{g} of the third embodiment in FIG. 8 are substantially similar to a waveguide 31, a transmission line 32, a dielectric substrate 33, a short-circuit metal layer 34, a metal member 35, a ground metal layer 36, a matching element 37, a dielectric layer 30, sizes p_{N2} and p_{W2}, and an effective wavelength λ_{g} of the second embodiment in FIG. 7, respectively.

In the description for FIG. 8, each two transmission lines 42 extend in both directions out of two directions away from the waveguide/transmission line converter 4 along a resonant length direction of the matching element 47. As a modified example of FIG. 8, a plurality of transmission lines 42 may extend in one direction while a single or a plurality of transmission lines 42 may extend in another direction, out of the two directions away from the waveguide/transmission line converter 4 along the resonant length direction of the matching element 47.

Thus, antennas can be arrayed in a direction perpendicular to a feed power direction only with one waveguide/transmission line converter 4, and high degree of freedom is provided to performance of an array antenna.

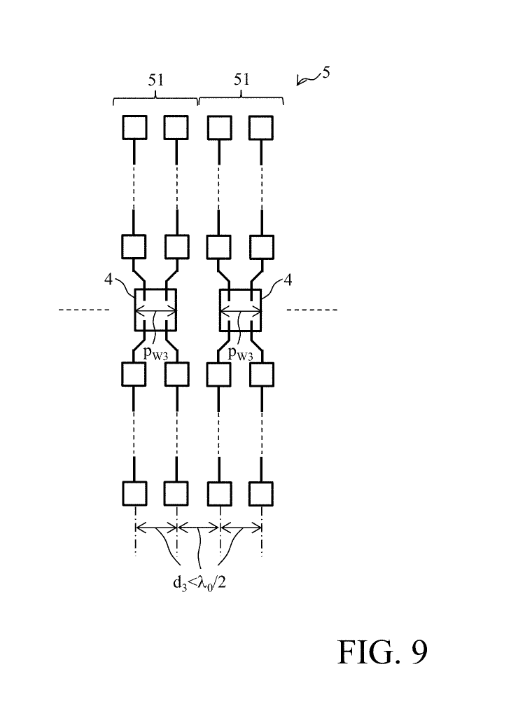

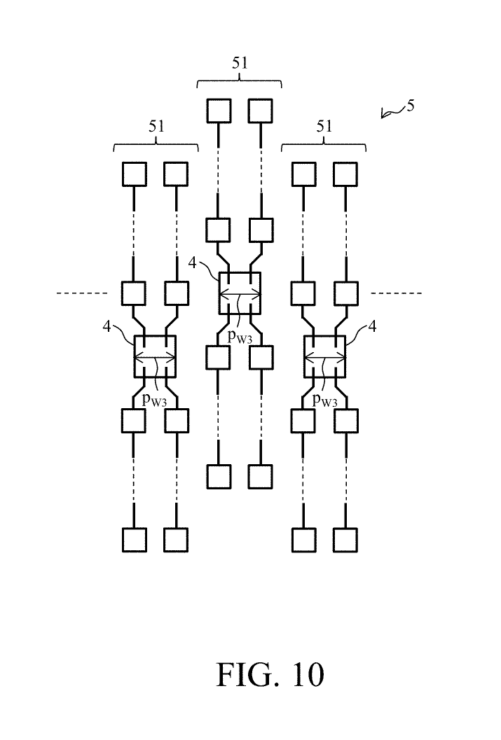

FIGS. 9 and 10 illustrate structures of an antenna device according to the third embodiment. In an antenna device 5, antenna elements are arranged in a lattice shape on a plane. In FIG. 9, the waveguide/transmission line converter 4 is arranged on a straight line in a horizontal direction of the drawing. In FIG. 10, the waveguide/transmission line converter 4 is arranged in a zigzag manner in the horizontal direction of the drawing. The antenna elements arranged in a lattice shape are divided per antenna elements 51 in every two columns. The antenna elements 51 in every two columns are fed power from the each two transmission lines 42 which are connected to the waveguide/transmission line converter 4 arranged in a center of every two columns and respectively extend in opposite directions (described in FIG. 8 as the third embodiment). The dielectric substrate 43 is a plane on which the antenna elements are arranged in a lattice shape. A cross-section of a wide wall of the waveguide 41 is arranged in a direction perpendicular to a direction of every two columns. A cross-section of a narrow wall of the waveguide 41 is arranged in a direction parallel to the direction of every two columns.

Here, in the waveguide/transmission line converter 4, the size p_{W3} (refer to FIG. 8) in a direction along the cross-section of the wide wall of the waveguide 41 out of sizes of patterns arranged on the surface of the dielectric substrate 43 can be reduced by a removal width 2n_{W3} or n_{W3} (refer to FIG. 8) of the metal member 45 and the ground metal layer 46 which have been removed along cross-sections of both or a cross-section of one of the two narrow walls of the waveguide 41. Specifically, compared to a size p_{W}′ in FIG. 1, the size p_{W3} in FIG. 8 is about ⅔ in millimeter wave application in which a size of the metal member 45 cannot be ignored. Therefore, in the antenna device 5, a distance d₃ between the antenna elements in the respective columns adjacent to each other can be made narrower than a length λ₀/2 that is equal to half a wavelength λ₀ of a radiated electromagnetic wave.

### INDUSTRIAL APPLICABILITY

The waveguide/transmission line converter and the antenna device according to the present disclosure are applicable for a purpose to downsize, at low cost, an antenna device in which a result of synthesis can form directivity having high gain in one arbitrary direction in a wide frequency range, grating lobe hardly occurs, and antenna elements are arranged in a lattice on a plane.

### REFERENCE SIGNS LIST

1, 3, 4, 1′: Waveguide/transmission line converter
2, 5, 2′: Antenna device
30, 40: Dielectric layer

### 11, 31, 41, 11′: Waveguide

12, 32, 42, 12′: Transmission line
13, 33, 43, 13′: Dielectric substrate
14, 34, 44, 14′: Short-circuit metal layer
15, 35, 45, 15′: Metal member
16, 36, 46, 16′: Ground metal layer

### 17, 37, 47, 17′: Matching Element

21, 51, 21′: Antenna elements in each column

What is claimed is:

1. A waveguide/transmission line converter configured to convert power transmitted by a waveguide and power transmitted by a transmission line to each other, the waveguide/transmission line converter comprising:
a dielectric substrate arranged in a manner blocking an opening of the waveguide;
a short-circuit metal layer arranged on a surface of the dielectric substrate and outside of the waveguide, and held at a potential same as a potential of the waveguide by a metal member penetrating the dielectric substrate along cross-sections of two wide walls of the waveguide or by a metal member penetrating the dielectric substrate along the cross-sections of the two wide walls and a cross-section of one of two narrow walls of the waveguide; and
a matching element arranged on a surface of the dielectric substrate and inside the waveguide, and coupled to the transmission line, in which a resonant length adapted to set up, as a standing wave, an electromagnetic wave having an effective wavelength in a surrounding environment of the dielectric substrate is in an electric field direction inside the waveguide and in a feed power direction of the transmission line.

2. The waveguide/transmission line converter according to claim 1, further comprising a dielectric layer formed on surfaces of the transmission line and the short-circuit metal layer.

3. The waveguide/transmission line converter according to claim 2, wherein the dielectric layer has a thickness of 0.2 times or less of an effective wavelength of an electromagnetic wave in the surrounding environment of the waveguide/transmission line converter.

4. The waveguide/transmission line converter according to claim 1, wherein a plurality of the transmission lines extend in at least one of two directions away from the waveguide/transmission line converter along a resonant length direction of the matching element.

5. An antenna device having antenna elements arranged in a lattice shape on a plane, wherein
the antenna elements arranged in a lattice shape are divided per antenna elements arranged in each column,
power is fed to the antenna elements arranged in each column by the transmission line connected to the waveguide/transmission line converter according to claim 1 arranged in a center of each column,
the dielectric substrate is a plane on which the antenna elements are arranged in a lattice shape,
a cross-section of a wide wall of the waveguide is arranged in a direction perpendicular to each column, and
a cross-section of a narrow wall of the waveguide is arranged in a direction parallel to each column.

6. The waveguide/transmission line converter according to claim 2, wherein a plurality of the transmission lines extend in at least one of two directions away from the waveguide/transmission line converter along a resonant length direction of the matching element.

7. An antenna device having antenna elements arranged in a lattice shape on a plane, wherein
the antenna elements arranged in a lattice shape are divided per antenna elements arranged in each column,
power is fed to the antenna elements arranged in each column by the transmission line connected to the waveguide/transmission line converter according to claim 2 arranged in a center of each column,
the dielectric substrate is a plane on which the antenna elements are arranged in a lattice shape,
a cross-section of a wide wall of the waveguide is arranged in a direction perpendicular to each column, and
a cross-section of a narrow wall of the waveguide is arranged in a direction parallel to each column.

8. The waveguide/transmission line converter according to claim 3, wherein a plurality of the transmission lines extend in at least one of two directions away from the waveguide/transmission line converter along a resonant length direction of the matching element.

9. An antenna device having antenna elements arranged in a lattice shape on a plane, wherein
the antenna elements arranged in a lattice shape are divided per antenna elements arranged in each column,
power is fed to the antenna elements arranged in each column by the transmission line connected to the waveguide/transmission line converter according to claim 3 arranged in a center of each column,
the dielectric substrate is a plane on which the antenna elements are arranged in a lattice shape,
a cross-section of a wide wall of the waveguide is arranged in a direction perpendicular to each column, and
a cross-section of a narrow wall of the waveguide is arranged in a direction parallel to each column.

10. An antenna device having antenna elements arranged in a lattice shape on a plane, wherein
the antenna elements arranged in a lattice shape are divided per antenna elements arranged in each column,
power is fed to the antenna elements arranged in each column by the transmission line connected to the waveguide/transmission line converter according to claim 4 arranged in a center of each column,
the dielectric substrate is a plane on which the antenna elements are arranged in a lattice shape,
a cross-section of a wide wall of the waveguide is arranged in a direction perpendicular to each column, and
a cross-section of a narrow wall of the waveguide is arranged in a direction parallel to each column.

11. An antenna device having antenna elements arranged in a lattice shape on a plane, wherein
the antenna elements arranged in a lattice shape are divided per antenna elements arranged in each column,
power is fed to the antenna elements arranged in each column by the transmission line connected to the waveguide/transmission line converter according to claim 6 arranged in a center of each column,
the dielectric substrate is a plane on which the antenna elements are arranged in a lattice shape,
a cross-section of a wide wall of the waveguide is arranged in a direction perpendicular to each column, and
a cross-section of a narrow wall of the waveguide is arranged in a direction parallel to each column.

12. An antenna device having antenna elements arranged in a lattice shape on a plane, wherein
the antenna elements arranged in a lattice shape are divided per antenna elements arranged in each column,
power is fed to the antenna elements arranged in each column by the transmission line connected to the waveguide/transmission line converter according to claim 8 arranged in a center of each column,
the dielectric substrate is a plane on which the antenna elements are arranged in a lattice shape,
a cross-section of a wide wall of the waveguide is arranged in a direction perpendicular to each column, and
a cross-section of a narrow wall of the waveguide is arranged in a direction parallel to each column.
